(19) United States
(12) Patent Application Publication
(10) Pub. No.: US 2006/0172786 A1
(43) Pub. Date: Aug. 3, 2006

(54) Compact telecommunication apparatus having upper and lower members slidable and rotatable relative to each other

(75) Inventor: I-Ming Lo, Taipei City (TW)

Correspondence Address: LADAS & PARRY, 26 WEST 61ST STREET, NEW YORK, NY, 10023, US

(73) Assignee: BENQ CORPORATION

(21) Appl. No.: 11/338,278

(22) Filed: Jan. 24, 2006

(30) Foreign Application Priority Data
Jan. 28, 2005 (TW) 94102687

(51) Int. Cl. H04M 1/00

(52) U.S. Cl. 455/575.3; 455/575.4

(57) ABSTRACT

A mobile phone includes a upper casing having a rail unit, a lower casing having a groove unit, and a slidable-and-rotatable mechanism that includes a slide auxiliary member, a rotatable member and a coupler shaft and that interconnects the upper and lower casings in such a manner that an assembly of the upper casing, the slide auxiliary member and the rotatable member is rotatable about the coupler shaft to a predetermined angle with respect to the lower casing once the assembly is moved to a predetermined position relative to the lower casing by virtue of sliding engagement between the rail unit and the groove unit.

### FIELD OF THE INVENTION

The present invention relates to a slidable-and-rotatable mechanism, more particularly to a slidable-and-rotatable mechanism for use in a wireless telecommunication apparatus, such as a mobile phone having upper and lower members. By employment of the mechanism in the mobile phone, the upper and lower members thereof are slidable relative to each other when the mobile phone is in the suspending mode and rotatable relative to each other when the mobile phone is in the operating mode.

### BACKGROUND OF THE INVENTION

Mobile phones of lately are designed in compact size in order to facilitate carrying thereof. The more convenient for the user to carry the mobile phone, the smaller the dimension should become. In order to eliminate the bulky size (such as stand alone type), some mobile phones are designed in foldable type (generally known as flip-phone) or slidable type in order to provide maximum dimension of the display (LCD). Referring to FIGS. 1A and 1B, a conventional mobile phone 10 of a slidable type is shown to include an upper casing 102 and a lower casing 104 connected slidably to the upper casing 102. When the user wishes to make a call, the lower casing 104 is moved outwardly in an axial direction of the upper casing 102 to a predetermined distance to expose the keypad mounted on the lower casing 104.

In the aforesaid conventional mobile phone, the upper and lower casings 102, 104 are not properly designed in view of ergonomics. It is noted that when a person is talking into a phone, the mouth and ear of the user cooperatively form an obtuse angle therebetwen. The straight configuration of the conventional mobile phone provides poor transmitting voice if the user draws the earphone (of the upper casing 102) near his ear since the approach of the earphone toward the ear consequently result in departure of the speaker away from the user's mouth and vice versa.

### SUMMARY OF THE INVENTION

The object of the present invention is to provide a mobile phone having upper and lower members and a slidable-and-rotatable mechanism that interconnects the upper and lower members in such a manner that the upper and lower members are slidable relative to each other when the mobile phone is in the suspending mode and rotatable relative to each other when the mobile phone is in the operating mode.

A telecommunication apparatus in accordance with the present invention includes: an upper member having a rail unit; a lower member disposed below the upper member and having a guiding groove unit aligned with the rail unit; a slide auxiliary member disposed between the upper and lower members and connected securely to the upper member in such a manner to permit sliding movement between the upper and lower members; a rotatable member disposed between the upper and lower members and connected securely to the slide auxiliary member; and a coupler shaft having a first end coupled to the rotatable member and a second end extending into the lower member to permit rotation of an assembly of the upper member, the slide auxiliary member and the rotatable member to a predetermined angle with respect to the lower member once the assembly is moved to a predetermined position relative to the lower member by virtue of sliding engagement between the rail unit and the groove unit.

In a second aspect of the present invention, a slidable-and-rotatable mechanism is provided, wherein the mechanism includes: an upper member having a rail unit; a lower member disposed below the upper member and having a guiding groove unit aligned with the rail unit; a slide auxiliary member disposed between the upper and lower members and connected securely to the upper member in such a manner to permit sliding movement between the upper and lower members; a rotatable member disposed between the upper and lower members and connected securely to the slide auxiliary member; and a coupler shaft having a first end coupled to the rotatable member and a second end extending into the lower member to permit rotation of an assembly of the upper member, the slide auxiliary member and the rotatable member to a predetermined angle with respect to the lower member once the assembly is moved to a predetermined position relative to the lower member by virtue of sliding engagement between the rail unit and the groove unit.

In a third aspect of the present invention, a rotatable mechanism is provided, wherein the rotatable mechanism includes: an upper member having a rail unit; a lower member disposed below the upper member and having a guiding groove unit aligned with the rail unit; a slide auxiliary member disposed between the upper and lower members and connected securely to the upper member in such a manner to permit sliding movement between the upper and lower members; a rotatable member disposed between the upper and lower members and connected securely to the slide auxiliary member; and a coupler shaft having a first end coupled to the rotatable member and a second end extending into the lower member to permit rotation of an assembly of the upper member, the slide auxiliary member and the rotatable member to a predetermined angle with respect to the lower member once the assembly is moved to a predetermined position relative to the lower member by virtue of sliding engagement between the rail unit and the groove unit.

### BRIEF DESCRIPTION OF THE DRAWINGS

Other features and advantages of this invention will become more apparent in the following detailed description of the preferred embodiment of this invention, with reference to the accompanying drawings, in which:

FIGS. 1A and 1B show perspective views, illustrating a conventional mobile phone in the use and non-used positions;

FIG. 2 is an exploded view of the preferred embodiment of a mobile phone of the present invention;

FIG. 3 is a perspective view of a slide auxiliary member and a rotatable member employed in the preferred embodiment of the mobile phone of the present invention;

FIG. 4 illustrates how the slide auxiliary member and the rotatable member of FIG. 3 are mounted to a lower casing of the preferred embodiment;

FIG. 5 illustrates how the lower casing is coupled to an upper casing of the preferred embodiment with the assistance of the slide auxiliary member and the rotatable member shown in FIG. 3;

FIG. 6A shows a perspective and upside down view of the upper casing in the preferred embodiment;

FIG. 6B shows a perspective view of the lower casing in the preferred embodiment;

FIG. 7A is a perspective view of the slide auxiliary member employed in the preferred embodiment of the mobile phone according to the present invention;

FIG. 7B is another perspective view of the slide auxiliary member employed in the preferred embodiment of the mobile phone according to the present invention;

FIGS. 8A, 8B 8C are perspective views of the preferred embodiment of the mobile phone according to the present invention in the used and non-used positions;

FIG. 9 illustrates how the rotatable member is mounted to the lower casing in the preferred embodiment of the mobile phone according to the present invention; and

FIGS. 10A, 10B and 10C respectively show side sectional views of the mobile phone according to the present invention in use.

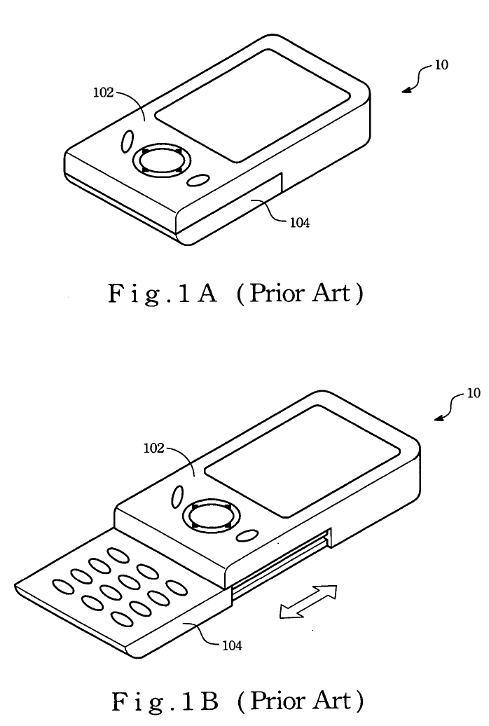

### DETAILED DESCCRIPTIONS OF THE PREFERRED EMBODIMENT

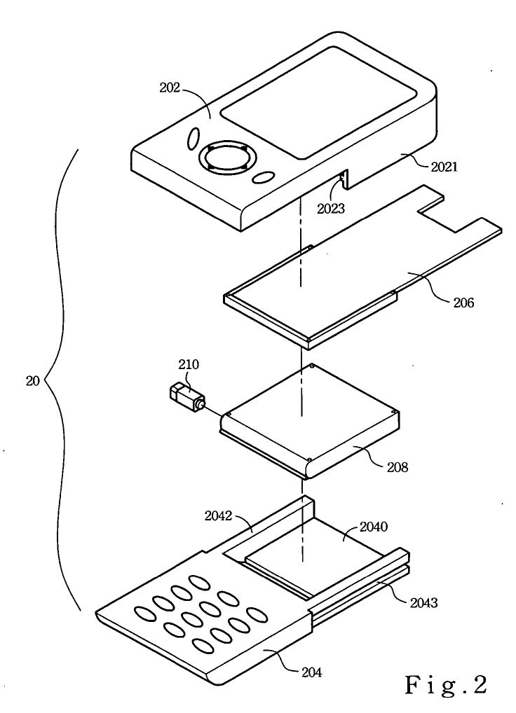

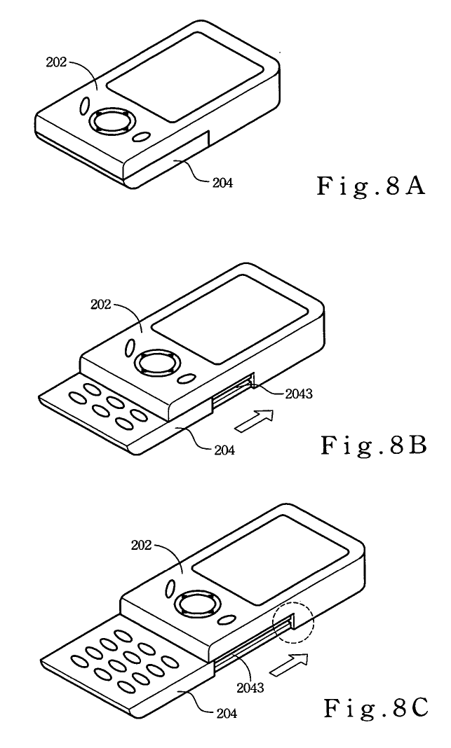

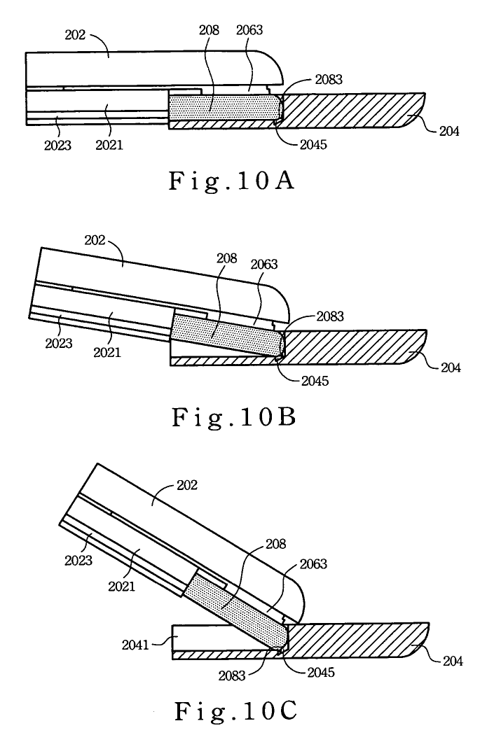

Referring to FIG. 2, an exploded view of the preferred embodiment of a wireless telecommunication apparatus (hereinafter a mobile phone) according to the present invention is shown to include an upper member 202, a lower member 204, and a slidable-and-rotatable mechanism that interconnects the upper and lower members 202, 204 to permit rotation of the upper member 202 to a predetermined angle with respect to the lower member 204 (see FIGS. 10A, 10B and 10C) once the former is moved to a predetermined position (see FIGS. 8A, 8B and 8C) relative to the latter. The slidable-and-rotatable mechanism generally includes a slide auxiliary member 206, a rotatable member 208 and a coupler shaft 210. In order better understanding of the present invention, the upper and lower members will be named hereinafter as upper and lower casing.

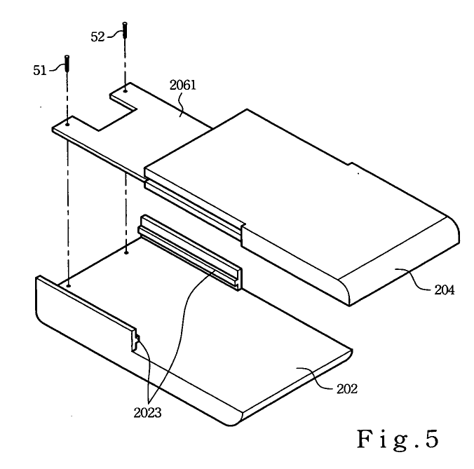

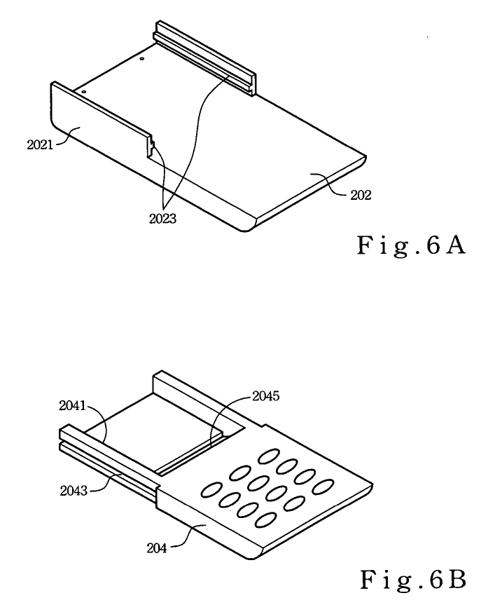

The upper and lower casings 202, 204 can be made from ABS plastics or any other materials in order to provide sufficient stiffness and rigidity so as to protect the electronic components disposed therein. As illustrated, the upper casing 202 (shown in upside down views in FIGS. 5 and 6A) has two opposite sides and left and right side walls 2021 (see FIG. 2) extending respectively and downwardly from the opposite sides. The left and right side walls 2021 of the upper casing 202 have outer wall surfaces formed with two parallel rails 2023 which cooperatively defines a rail unit. The upper casing 202 also has an antenna unit (not shown) for transmitting and receiving radio signals and a printed circuit board (not shown) for processing the incoming and outgoing signals. Since the construction of the antenna unit and the printed circuit board is not the relevant feature of the present invention, a detailed description thereof is omitted herein for the sake of brevity.

The lower casing 204 is disposed below the upper casing 202, and has opposite left and right side walls 2042 defining a receiving space 2040 therebetween and an open end 2041. The left and right side walls 2042 of the lower casing 204 have outer wall surfaces formed with two parallel grooves 2043 (see FIG. 4) that are respectively aligned with and that receive the rails 2023 of the upper casing 202. The parallel grooves 2043 cooperatively define a groove unit of the lower casing 204. Under this condition, the upper and lower casings 202, 204 are slidable relative to each other such that when the mobile phone of the present invention is not use, the lower casing 204, which usually contains the keypad for inputting data, can be retracted into the upper casing 202 in order to kept the mobile phone in a suspending mode (non-used position) (see FIG. 8A). When it is desired to operate the keypad, the lower casing 204 can be extended outwardly from the upper casing 202 as best shown in FIGS. 8B and 8C. Due to its compact size, the mobile phone of the present invention is easy to be carried along. The lower casing 204 further has a closed end that is located opposite to the open end 2041, that confines one side of the receiving space 2040 and that is formed with a hindrance rib 2045 extending in a left and right direction of the lower casing 204. In the preferred embodiment, the hindrance rib 2045 is formed on a bottom surface of the receiving space 2040 adjacent to the closed end of the lower casing 204.

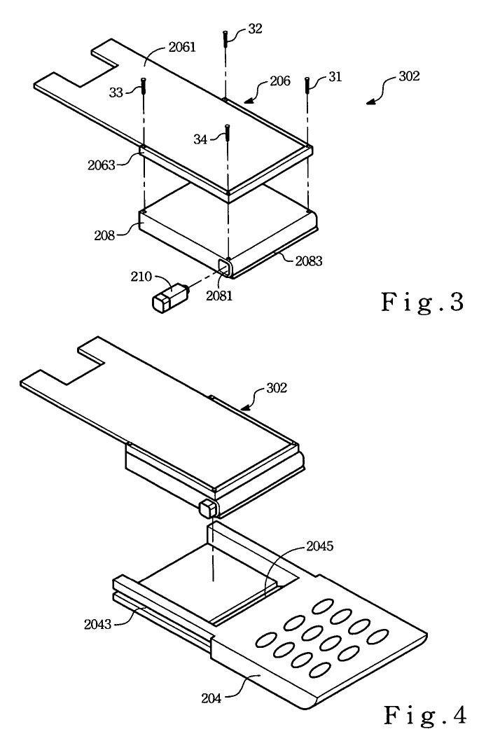

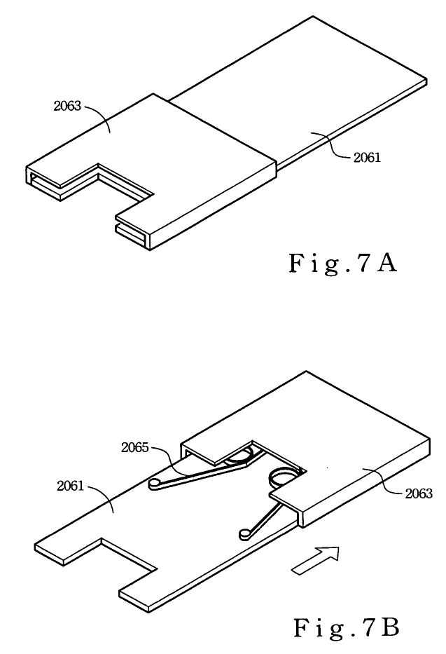

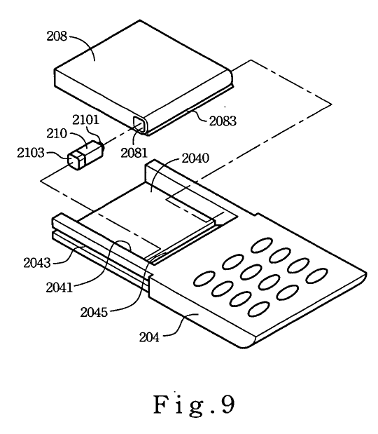

The slide auxiliary member 206 is disposed between the upper and lower casing 202, 204, and includes an elongated plate 2061, a retention casing 2063 and an urging member 2065 (a torsion spring). The elongated plate 2061 has a first end portion fixed to the upper casing 202 via two fastener screws 51, 52 (see FIG. 5) and a second end portion inserted slidably into the retention casing 206 (see FIG. 7B). The torsion spring 2065 is disposed between and interconnects slidably the elongated plate 2061 and the retention casing 2063 in such a manner to prevent removal of the elongated plate 2061 and the retention casing 2063 from each other. Four fastener screws 31, 32, 33, 34 extend through the retention casing 2063, and engage the rotatable member 208 (see FIG. 3), thereby fastening the two together. The rotatable member 208 is preferably a rectangular block, and is disposed rotatably within the receiving space 2040 in the lower casing 204 by means of the coupler shaft 210. The rotatable member 208 has an engagement groove 2083 that is located at the lower end thereof. The coupler shaft 210 has a first end 2101 coupled to a mounting hole 2081 (see FIG. 9) in a side wall of the rotatable member 208 and a second end 2103 extending into an inner side wall 2041 of the receiving space 2040 in the lower casing 204 (see FIG. 4) in such a manner to permit rotation of assembly of the upper member 202, the slide auxiliary member 206 and the rotatable member 208 to a predetermined angle with respect to the lower casing 204 once the assembly is moved to a predetermined position relative to the lower casing 204 (see FIG. 10B).

Note that the predetermined position of the assembly is defined after disengagement between the rails 2023 of the upper casing 202 and the grooves 2043 in the lower casing 204, as shown in FIG. 10A. As illustrated in FIG. 10C, the assembly can not be tilted further when the engagement groove 2083 in the rotatable member 208 engages the hindrance rib 2045 of the lower casing 204, At this condition, the upper casing 202 is disposed at the best position in view of ergonomics, since the upper casing 202 having the earphone and the lower casing 204 having the speaker are located closely to the user's ear and mouth.

To summarize the above paragraphs, the present invention provides the slidable-and-rotatable mechanism of simple structure to eliminate the drawbacks encountered during use of the conventional mobile phone. Note that no complicated process is involved for producing the mechanism, thereby reducing the manufacturing cost. In addition, since the mechanism is disposed between the upper and lower casings of the present mobile phone, the outward appearance thereof is not affected.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A telecommunication apparatus comprising:
an upper member having a rail unit;
a lower member disposed below said upper member, and having a guiding groove unit aligned with said rail unit;
a slide auxiliary member disposed between said upper and lower members, and connected securely to said upper member in such a manner to permit sliding movement between said upper and lower members;
a rotatable member disposed between said upper and lower members, and connected securely to said slide auxiliary member; and
a coupler shaft having a first end coupled to said rotatable member and a second end extending into said lower member to permit rotation of an assembly of said upper member, said slide auxiliary member and said rotatable member to a predetermined angle once said assembly is moved to a predetermined position relative to said lower member by virtue of sliding engagement between said rail unit and said groove unit.

2. The telecommunication apparatus according to claim 1, wherein said slide auxiliary member includes an elongated plate fixed to said upper member, a retention casing that receives slidably said elongated plate therein and that is fixed to said rotatable member, and an urging member disposed between and interconnecting slidably said elongated plate and said retention casing in such a manner to prevent removal of said elongated plate and said retention casing from each other.

3. The telecommunication apparatus according to claim 1, wherein said assembly is rotatable about said coupler shaft to said predetermined angle once said assembly is movement to said predetermined position with respect to said lower member, wherein said predetermined position of said assembly is defined after disengagement between said rail unit and said groove unit.

4. The telecommunication apparatus according to claim 1, wherein said upper member has two opposite sides and left and right side walls extending respectively and downwardly from said opposite sides, said left and right side walls of said upper member having outer wall surfaces formed with two parallel rails which cooperatively defines said rail unit.

5. The telecommunication apparatus according to claim 4, wherein said lower member has opposite left and right side walls defining a receiving space therebetween and an open end for extension of said rotatable member into said receiving space such that said rotatable member is disposed rotabaly within said receiving space, said left and right side walls of said lower member having outer wall surfaces formed with two parallel grooves that receive said rails and that define said groove unit of said lower member.

6. The telecommunication apparatus according to claim 5, wherein said lower member has a closed end that is located opposite to said open end, that confines one side of said receiving space and that is formed with a hindrance rib extending in a left and right direction of said lower member, said rotatable member having an engagement groove that is disposed adjacent to said coupler shaft and that engages said hindrance rib in such a manner to permit resting of said assembly at said predetermined angle with respect to said lower member once said assembly is moved to said predetermined position.

7. A slidable-and-rotatable mechanism comprising:
an upper member having a rail unit;
a lower member disposed below said upper member, and having a guiding groove unit aligned with said rail unit;
a slide auxiliary member disposed between said upper and lower members, and connected securely to said upper member in such a manner to permit sliding movement between said upper and lower members;
a rotatable member disposed between said upper and lower members, and connected securely to said slide auxiliary member; and
a coupler shaft having a first end coupled to said rotatable member and a second end extending into said lower member to permit rotation of an assembly of said upper member, said slide auxiliary member and said rotatable member to a predetermined angle once said assembly is moved to a predetermined position relative to said lower member by virtue of sliding engagement between said rail unit and said groove unit.

8. The slidable-and-rotatable mechanism according to claim 7, wherein said slide auxiliary member includes an elongated plate fixed to said upper member, a retention casing that receives said elongated plate slidably therein and that is fixed to said rotatable member, and an urging member disposed between and interconnecting slidably said elongated plate and said retention casing in such a manner to prevent removal of said elongated plate and said retention casing from each other.

9. The slidable-and-rotatable mechanism according to claim 7, wherein said assembly is rotatable about said coupler shaft to said predetermined angle once said assembly is movement to said predetermined position with respect to said lower member, wherein said predetermined position of said assembly is defined after disengagement between said rail unit and said groove unit.

10. The slidable-and-rotatable mechanism according to claim 7, wherein said upper member has two opposite sides and left and right side walls extending respectively and downwardly from said opposite sides, said left and right side walls of said upper member having outer wall surfaces formed with two parallel rails which cooperatively defines said rail unit.

11. The slidable-and-rotatable mechanism according to claim 10, wherein said lower member has opposite left and right side walls defining a receiving space therebetween and an open end for extension of said rotatable member into said receiving space such that said rotatable member is disposed rotatably within said receiving space, said left and right side walls of said lower member having outer wall surfaces formed with two parallel grooves that receive said rails and that define said groove unit of said lower member.

12. The slidable-and-rotatable mechanism according to claim 11, wherein said lower member has a closed end that is located opposite to said open end, that confines one side of said receiving space and that is formed with a hindrance rib extending in a left and right direction of said lower member, said rotatable member having an engagement groove that is disposed adjacent to said coupler shaft and that engages said hindrance rib in such a manner to permit resting of said assembly at said predetermined angle with respect to said lower member once said assembly is moved to said predetermined position.

13. The slidable-and-rotatable mechanism according to claim 11, wherein the mechanism is used in a telecommunication apparatus that includes said lower member having a keypad and said upper member having an LCD screen for displaying information inputted by actuation of said keypad.

14. A rotatable mechanism comprising:
an upper member having a rail unit;
a lower member disposed below said upper member, and having a guiding groove unit aligned with said rail unit;
a slide auxiliary member disposed between said upper and lower members, and connected securely to said upper member in such a manner to permit sliding movement between said upper and lower members;
a rotatable member disposed between said upper and lower members, and connected securely to said slide auxiliary member; and
a coupler shaft having a first end coupled to said rotatable member and a second end extending into said lower member to permit rotation of assembly of said upper member, said slide auxiliary member and said rotatable member to a predetermined angle with respect to said lower member once said assembly is moved to a predetermined position relative to said lower member by virtue of sliding engagement between said rail unit and said groove unit.

15. The rotatable mechanism according to claim 14, wherein said slide auxiliary member includes an elongated plate fixed to said upper member, a retention casing that receives said elongated plate slidably therein and that is fixed to said rotatable member, and an urging member disposed between and interconnecting slidably said elongated plate and said retention casing in such a manner to prevent removal of said elongated plate and said retention casing from each other.

16. The rotatable mechanism according to claim 14, wherein said assembly is rotatable about said coupler shaft to said predetermined angle once said assembly is movement to said predetermined position with respect to said lower member, wherein said predetermined position of said assembly is defined after disengagement between said rail unit and said groove unit.

17. The rotatable mechanism according to claim 14, wherein said upper member has two opposite sides and left and right side walls extending respectively and downwardly from said opposite sides, said left and right side walls of said upper member having outer wall surfaces formed with two parallel rails which cooperatively defines said rail unit.

18. The slidable-and-rotatable mechanism according to claim 17, wherein said lower member has opposite left and right side walls defining a receiving space therebetween and an open end for extension of said rotatable member into said receiving space such that said rotatable member is disposed rotabaly within said receiving space, said left and right side walls of said lower member having outer wall surfaces formed with two parallel grooves that receive said rails and that define said groove unit of said lower member.

19. The slidable-and-rotatable mechanism according to claim 18, wherein said lower member has a closed end that is located opposite to said open end, that confines one side of said receiving space and that is formed with a hindrance rib extending in a left and right direction of said lower member, said rotatable member having an engagement groove that is disposed adjacent to said coupler shaft and that engages said hindrance rib in such a manner to permit resting of said assembly at said predetermined angle with respect to said lower member once said assembly is moved to said predetermined position.
